(19) United States
(12) Patent Application Publication
(10) Pub. No.: US 2003/0224720 A1
(43) Pub. Date: Dec. 4, 2003

(54) Communication terminal with user-configurable memory

(76) Inventor: Peter Jung, Otterberg (DE)

Correspondence Address: LERNER AND GREENBERG, P.A., POST OFFICE BOX 2480, HOLLYWOOD, FL, 33022-2480, US

(21) Appl. No.: 10/447,651

(22) Filed: May 29, 2003

Related U.S. Application Data
(63) Continuation of application No. PCT/DE01/04509, filed on Nov. 27, 2001.

(30) Foreign Application Priority Data
Nov. 30, 2000 (DE) 100 59 524.3

(51) Int. Cl. H04H 1/00

(52) U.S. Cl. 455/3.05; 455/412.1

(57) ABSTRACT

A communication terminal, particularly a mobile phone, can be identified by settable audible and/or visual features. The communication terminal has a user-configurable memory in which a user can store a file that can be retrieved and executed by control commands from a control unit, such as a microprocessor. The file is of a nature such that executing it allows a user to identify the communication terminal by way of audible and/or visual identifying features.

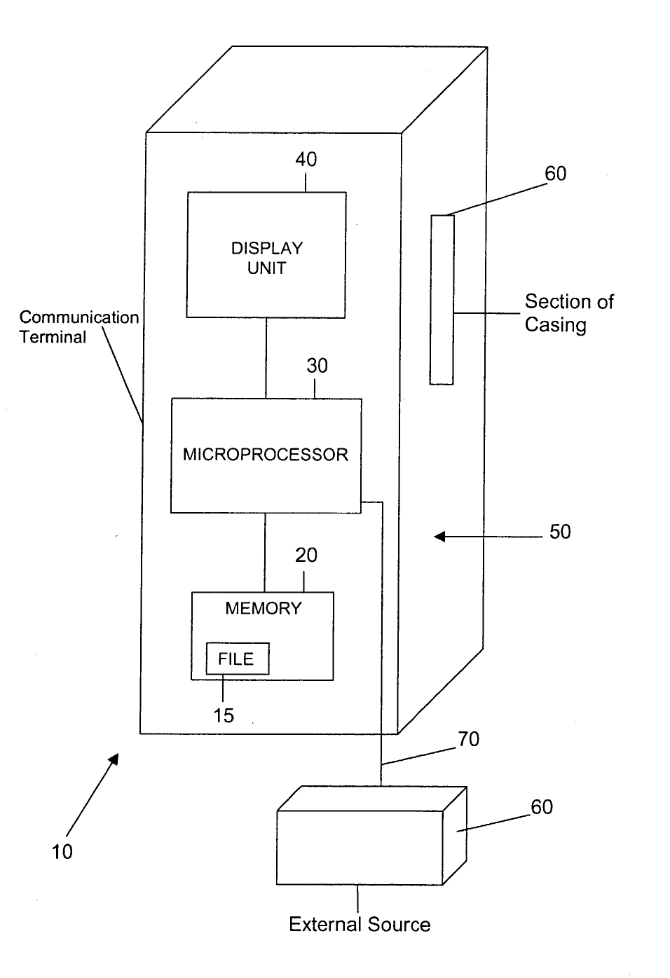

### CROSS-REFERENCE TO RELATED APPLICATION

This application is a continuation of copending International Application No. PCT/DE01/04509, filed Nov. 27, 2001, which designated the United States and was not published in English.

### BACKGROUND OF THE INVENTION

Field of the Invention

The invention relates to a communication terminal, which is in particular, a mobile phone. In this regard, the invention concerns itself with the problem of enabling a user to visually or audibly identify and recognize a particular communication terminal.

A fundamental problem of communication terminals, such as mobile phones, which are available on the market today is that their visual appearance or audible signaling, such as ringtone signaling, does not allow them to be distinguished from one another very easily. This means that their users cannot quickly identify them from among a plurality of other appliances using visual or audible features. Although there is now an array of different manufacturers of mobile phones who have developed various models, which means that a certain diversity of visual appearances has been achieved for these appliances in this regard, the external visual distinguishing features are often determined by technical features of the appliances to which many users do not immediately direct their attention. Audible distinguishing features are currently limited to a number of different, more or less monotonous signal melodies which are retrieved for ringtone signaling. Since most manufacturers provide only a few different ringtone signals, identification based on these audible signals is likewise limited.

The problem described above can arise in various situations, and the increasing proliferation of mobile phones in the population makes such situations more and more likely. By way of example, a relatively large number of people can be situated in a room and these people can carry mobile phones of which the majority are in standby mode. In this situation, it is a problem if one of these communication terminals receives a call, but the ringtone signal that can be heard is the same as the ringtone signal used by other communication terminals. If the people involved are gathered in a relatively confined space, then confusion arises about which person has now been called on his mobile phone. There is thus a need for greater audible distinguishability for the communication terminals involved.

Another situation arises, by way of example, when the communication terminals carried by a relatively large number of people have to be handed over before entering a room or a transport device such as an aircraft, for example, and are kept at a common location and redistributed to the users after a particular time. As already mentioned, it is not readily possible for particular appliances to be identified quickly. To facilitate this task, casing shells have been developed which make it possible to distinguish the mobile phones more easily. However, these casing shells can usually be used only in conjunction with one particular mobile phone. In addition, they are relatively complicated to use. Finally, the visual distinguishing features which they can achieve are limited in their effect.

### SUMMARY OF THE INVENTION

It is accordingly an object of the invention to provide a communication terminal, particularly a mobile phone, which overcomes the above-mentioned disadvantages of the prior art apparatus of this general type.

In particular, it is an object of the invention to provide a communication terminal, particularly a mobile phone, which allows the users to audibly and/or visually identify a communication terminal, or which allows the users of a plurality of communication terminals to distinguish the communication terminals from one another in a relatively fast and reliable manner.

With the foregoing and other objects in view there is provided, in accordance with the invention, a communication terminal including a control unit; and at least one memory for storing a file that can be retrieved and executed by control commands from the control unit. Upon execution, the file allows a user to identify the communication terminal by audible and/or visual identifying features. The communication terminal, the control unit and the memory are configured for obtaining the file from an source external.

The present invention is based on the fundamental concept of visually and/or audibly distinguishing a communication terminal from other appliances in a manner that is defined by the user himself. The particular visual and/or audible distinguishing features are chosen by the user himself and are stored by the user in a memory inside the appliance, from where they can be retrieved by a control unit such as a microprocessor when required. The distinguishing features are stored in the memory in the form of a file.

Both visual and audible distinguishing features can be stored in the form of a respective file in two different memory areas of the memory. If appropriate, however, there can also be two different memories for storing visual and audible features.

Specifically, a communication terminal, particularly a mobile phone, thus has a control unit, particularly a microprocessor, and at least one memory in which a user can store a file that can be retrieved and executed by control commands from the microprocessor. The file is of a nature such that executing it allows a user to identify the communication terminal by way of visual and/or audible identifying features.

Other features which are considered as characteristic for the invention are set forth in the appended claims.

Although the invention is illustrated and described herein as embodied in a communication terminal with user-configurable memory, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The drawing figure is block diagram of a communication terminal and an external source in which the casing of the communication terminal is schematically illustrated.

### DESCRIPTION OF THE PREFERRED EMBODIMENTS

Referring now to the sole drawing figure in detail, there is shown a communication terminal 10 that is designed to cope with the problem situations described in the introduction. By way of example, the file 15 stored in the memory 20 can represent an audible tone sequence. In the event of a call arriving on the communication terminal, the file 15 can be retrieved and the tone sequence can be output as a ringtone signal. Unlike with conventional solutions, the user can determine the file 15 that will be loaded into the memory 20 and hence can himself determine the audible tone sequence. The user can put the chosen file 15 into the memory 20 autonomously, preferably using a menu-controlled flow controller. The great advantage in this context is that the file 15 can have any desired format in principle, for example, even an MP3 format. The user is thus not restricted to selecting just one selection from particular prescribed, more or less monotonous tone sequences for ringtone signaling. Instead, he can load any desired tone sequence which he has chosen himself into the memory 20. By way of example, he can use suitable interfaces to route an MP3 file from the Internet or from an MP3 player to the communication terminal, where it is then loaded into the memory 20 under the control of the microprocessor 30. The MP3 file or a file in another format can be transmitted to the communication terminal 10 from various sources in various ways. The transmission can be made using wires, e.g. using a direct Internet connection for the mobile phone, or wirelessly, e.g. using IrDA, Bluetooth, or, in the case of a mobile telephone, using the data transmission of a mobile radio standard. A prerequisite in this case is that the communication terminal 10 has suitable software and hardware for playing the MP3 file. The user can thus store an MP3 file in his communication terminal 10, can select this file as the ringtone, and can thus make his communication terminal 10 identifiable.

In another embodiment of a communication terminal 10 in accordance with the invention, the file 15 can represent a visual information item relating to the appearance of the appliance's casing. To this end, the casing 50 of the communication terminal 10 additionally needs to be of a nature such that processor-controlled retrieval of the file 15 allows a visual alteration to be made on at least one section of the casing surface. A prerequisite in this case is thus that the communication terminal's casing 50 is of a nature such that software-based alteration of the appearance becomes possible. By way of example, the casing 50 could allow a color change based on voltage or temperature. The casing 50 can also have surface sections 60 on which image files can be displayed in a similar manner to that on a conventional display. In one simple type of embodiment, however, the casing 50 can also merely have particular punctiform or expanded light sources such as LEDs of prescribed color or prescribed different colors or can have an appropriate matrix-like arrangement (array) of such luminous sources. Depending on the form of the casing properties, the user determines the appliance's appearance by way of menu control, for example, by selecting a predefined or else user-defined image file. This can be in a particular format, for example, in a BMP format, and can have been stored in the memory 20 of the communication terminal 10 using the SIM card, by radio or by wire, for example.

In another embodiment of the communication terminal 10, the only prerequisite is a corresponding appliance which has a display unit, for example a liquid crystal display unit 40, in a manner which is known per se. In this case, the user-defined file 15 stored in the memory 20 represents a visual information item relating to the image information item which is to be displayed on the display unit 40. Retrieval of the file then allows this image information item to be displayed on the display unit 40. In this example too, the appliance's user interface formed by the display unit 40 is controlled by the user himself. The visual information item used which is held in the file 15 can be either prescribed or user-defined pictograms (icons), for example. Similarly, the selection and the scope of functions of the user menus are determined by the user himself, e.g. by enabling or suppressing particular options. The image file in question can also be in a BMP format in this exemplary embodiment.

The invention provides for the corresponding communication terminal 10 or the control unit in the form of a microprocessor 30, for example, to be equipped and programmed, in terms of hardware and software, to allow reception of the file transmitted from an external source 60 to the communication terminal 10 and subsequent storage of the file 15 in the memory 20. One basic prerequisite is that the memory 20 be large enough to hold files of the type described. The file can be wirelessly transmitted from the external source 60 or can be transmitted via wires 70, which have been schematically illustrated.

In the case of an audible identification of the communication terminal 10, provision is made for the audio file in question, particularly an MP3 file, to be retrieved by the microprocessor 30 only when there is a call and it is necessary to activate ringtone signaling. However, provision can also be made to enable the audio file to be retrieved and hence for the tone sequence it contains to be played when required by virtue of the user pressing a key.

In the case of visual identifiability of the communication terminal 10 by altering the casing 50 or by displaying image files on the display unit 40, provision can likewise be made for the user to be able to press a key in order to retrieve and execute the image file in question, for example, in situations in which he leaves his appliance in a storage location together with other appliances, so that he can subsequently identify his appliance again without any relatively great complexity of search.

I claim:

1. A communication terminal, comprising:
a control unit; and
at least one memory for storing a file that can be retrieved and executed by control commands from said control unit;
upon execution, said file allowing a user to identify the communication terminal by audible and/or visual identifying features;
said control unit and said memory configured for obtaining said file from an source external.

2. The communication terminal according to claim 1, wherein said file can be wirelessly obtained from said external source.

3. The communication terminal according to claim 1, wherein said file can be obtained from said external source via wires.

4. The communication terminal according to claim 1, wherein said control unit is a microprocessor.

5. The communication terminal according to claim 1, wherein:
said file represents an audible tone sequence; and
in an event of a call, said file is retrieved and execution of said file results in an output of a tone sequence as a ringtone signal.

6. The communication terminal according to claim 5, wherein said file can be stored in an MP3 format.

7. The communication terminal according to claim 1, further comprising:
a casing having at least one section capable of undergoing a visual alteration in response to an execution of said file;
said casing housing said control unit and said memory; and
said file representing a visual information item relating to an appearance of said casing.

8. The communication terminal according to claim 7, wherein said file can be stored in a BMP format.

9. The communication terminal according to claim 7, wherein
said control unit is programmed to allow reception of said file when said file is being transmitted from the external source; and
said control unit is programmed for subsequently storing said file in said memory.

10. The communication terminal according to claim 1, further comprising:
a display unit;
said file representing a visual information item relating to an image information item to be displayed on said display unit; and
upon retrieval, said file enabling said image information item to be displayed on said display unit.

11. The communication terminal according to claim 10, wherein said visual information item is a pictogram.

12. The communication terminal according to claim 10, wherein said file can be stored in a BMP format.

13. The communication terminal according to claim 10, wherein
said control unit is programmed to allow reception of said file when said file is being transmitted from the external source; and
said control unit is programmed for subsequently storing said file in said memory.

14. The communication terminal according to claim 10, wherein the communication terminal is a mobile phone.
